(19) United States
(12) Patent Application Publication
(10) Pub. No.: US 2010/0194007 A1
(43) Pub. Date: Aug. 5, 2010

(54) NOVEL FILTRATION SYSTEM FOR LARGE CAST IRON CASTINGS

(76) Inventors: Donald B. Craig, Fletcher, NC (US); Steven H. Martin, Hendersonville, NC (US); Rudolph A. Olson, Hendersonville, NC (US); Robert Simpson, Sycamore, IL (US); Eldon Rohlena, Dekalb, IL (US)

Correspondence Address: NEXSEN PRUET, LLC, P.O. BOX 10648, GREENVILLE, SC, 29603, US

(21) Appl. No.: 12/679,720

(22) PCT Filed: Sep. 25, 2008
(86) PCT No.: PCT/US08/77761

§ 371 Date: Mar. 24, 2010

Related U.S. Application Data
(60) Provisional application No. 60/975,266, filed on Sep. 26, 2007.
(60) Provisional application No. 61/045,015, filed on Apr. 15, 2008.
(60) Provisional application No. 61/060,842, filed on Jun. 12, 2008.

(51) Int. Cl. B01D 25/00; B01D 29/50

(52) U.S. Cl. 266/227

(57) ABSTRACT

An improved filter assembly for molten metal is described. The assembly has a canister with at least one port wherein the port allows filtered molten metal to flow from the canister. A plurality of filter elements is in the canister wherein the filter elements separate a volume of the canister into a primary chamber and a secondary chamber wherein the secondary chamber is in direct flow communication with the port. A ported cover is over the canister wherein the ported cover prohibits unfiltered molten metal from flowing directly into the secondary chamber. The molten metal flows from the primary chamber to the secondary chamber through a filter element.

### CROSS-REFERENCE TO RELATED APPLICATIONS

The present application claims the benefit of pending U.S. Provisional Patent Application Nos. 60/975,266 filed Sep. 26, 2007; 61/045,015 filed Apr. 15, 2008 and 61/060,842 filed Jun. 12, 2008.

### BACKGROUND

The present disclosure is directed to a novel concept for a filtration system designed to filter large volumes of molten iron in a restricted space and in a limited period of time. More specifically, the present invention is directed to a radially diffusing filter assembly.

Large iron castings are filtered with either coarse strainer filters, coarse foam filters, a combination of strainer and foam filters or are not filtered at all. The individual filter, or the combination of the filters, is placed in a conventional manner in a runner bar system in either the vertical or horizontal position.

Filtering of large iron castings has long been considered difficult due, in part, to the combination of the large volume of iron and the high flow rate of iron required to fill the mold in the desired time period. This combination of volume and flow rate creates stresses on the filters that generally exceed the design parameters for conventional placement of filters in the mold. Due to limited space within the mold, the foundry engineer is often forced to compromise on both the size and location of the filter within the mold. This design compromise usually results in either a mechanical failure of the filter or allows poorly filtered iron to enter the casting cavity within the mold resulting in a scrap casting or significant rework on the casting. Due to changes in the metal quality acceptance standards the need for clean iron castings has increased. The foundry engineer is now faced with the challenge of placing sufficient filter area to accommodate the volume and flow rate of iron required to fill the mold in the limited space available within the mold.

There has been an ongoing need for a method of filtering large volumes of molten iron efficiently.

### SUMMARY OF THE INVENTION

Provided in the present invention is a filter system, and method of use, wherein molten iron can be efficiency filtered.

A particular feature of the filter system, and method, is a filter assembly that can be inserted into an interior cavity of a Fischer Converter.

These and other advantages, as will be realized, are provided in a filter assembly for molten metal. The assembly has a canister with at least one port wherein the port allows filtered molten metal to flow from the canister. A plurality of filter elements is in the canister wherein the filter elements separate a volume of the canister into a primary chamber and a secondary chamber wherein the secondary chamber is in direct flow communication with the port. A ported cover is over the canister wherein the ported cover prohibits unfiltered molten metal from flowing directly into the secondary chamber. The molten metal flows from the primary chamber to the secondary chamber through a filter element.

Yet another embodiment is provided in a filter assembly. The filter assembly has a base plate with a face and a port. A multiplicity of filters is attached to the face forming a cavity. Molten metal passes through the multiplicity of filters into the cavity and then through the port.

Yet another embodiment is provided in an improved filter assembly. The filter assembly has a cover plate with at least one cover port. A bottom plate is provided parallel to the cover plate wherein the bottom plate has an exit port. A multiplicity of filters is between the ported cover and the bottom plate wherein the filters form a primary cavity in direct flow communication with the cover port and a secondary chamber in direct flow communication with the exit port and molten metal must passes through the filter to move from the primary cavity to the secondary cavity.

### BRIEF DESCRIPTION OF THE FIGURES

FIG. 1 is a top perspective view of an embodiment of the present invention.

FIG. 2 is an exploded view of an embodiment of the present invention.

FIG. 3 is a cross-sectional view taken along line 3-3 of FIG. 1.

FIG. 4 is a bottom perspective view of an embodiment of the present invention.

FIG. 5 is a top perspective exploded view of an embodiment of the present invention.

FIG. 6 is a bottom perspective view of an embodiment of the present invention.

FIG. 7 is a partial cut-away top perspective view of an embodiment of the present invention.

FIG. 8 is a partial cut-away top perspective view of an embodiment of the present invention.

FIG. 9 is a partial cut-away top perspective exploded view of an embodiment of the present invention.

FIG. 10 is a bottom perspective view of a top plate of the embodiment of FIG. 9.

FIG. 11 is a top perspective view of a bottom plate of the embodiment of FIG. 9.

### DETAILED DESCRIPTION

The present invention provides an improved filtration system and an improved method for effectively filtering large amounts of metal, particularly cast iron or ductile iron, rapidly. Filters are arranged to provide a radial flow of molten metal instead of a more linearly flow as typically employed in the art. By forcing a radial flow the available filtration surface area can be greatly increased while still maintaining a small face area thereby increasing the overall filter area without compromising the strength of the individual filter elements.

The invention will be described with reference to the various figures which form an integral non-limiting component of the instant invention. Throughout the description and figures similar elements will be numbered accordingly.

For the purposes of the present invention radial flow is defined as flow of molten metal through a filter in a direction which is non-linear, and preferably perpendicular, relative to the gross flow of molten iron. For the purposes of the present invention primary flow is predominantly in a parallel direction such as through a pipe or runner bar whereas the present invention comprises filters which are not perpendicular to the primary flow but instead radially arranged around the primary flow.

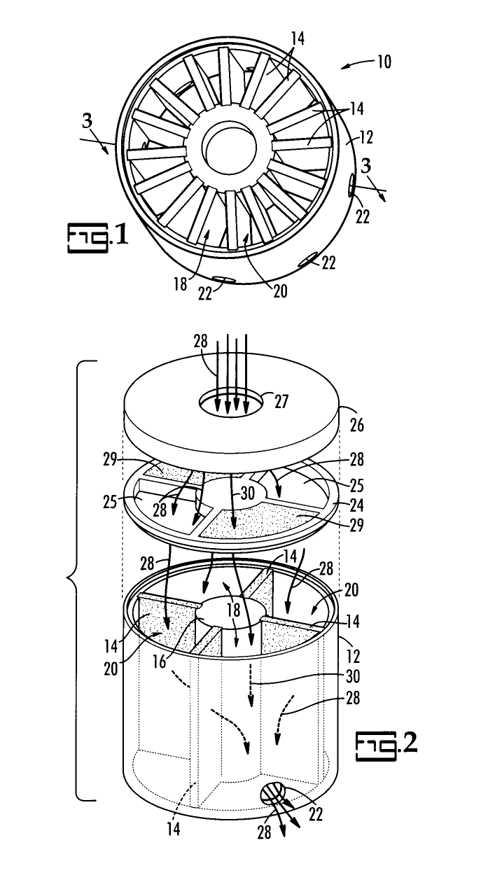

An embodiment of the invention is illustrated in FIG. 1. In FIG. 1, a partial filter canister, 10, is illustrated. The canister comprises a shell, 12, capable of receiving molten metal and passing the molten metal through specific ports which will be further explained herein. Within the shell are multiple filters, 14, radially arranged around a central core, 16. The filters are arranged such that the area within the canister is separated into primary chambers, 20, and secondary chambers, 18. The primary chambers and secondary chambers differ in that the secondary chambers allow molten metal to pass directly out of the canister through ports, 22, integral therewith. As would be realized, molten metal flows into a primary chamber, through a filter into a secondary chamber and then through a port as filtered metal.

The embodiment of FIG. 1 can be utilized in, at least, two filtering techniques. In one technique a solid ported cover can be employed wherein flow of molten metal directly into a secondary chamber is prohibited. In this method the molten metal must first enter a primary chamber and then pass through a filter to a secondary chamber prior to exiting a port. A second filtering technique employs a porous ported cover wherein the ports allow unfiltered molten metal to pass directly into a primary chamber whereas molten metal which passes through the porous ported filter may go into a secondary chamber. When a porous ported cover is utilized the molten metal is either filtered by the cover or by the filters.

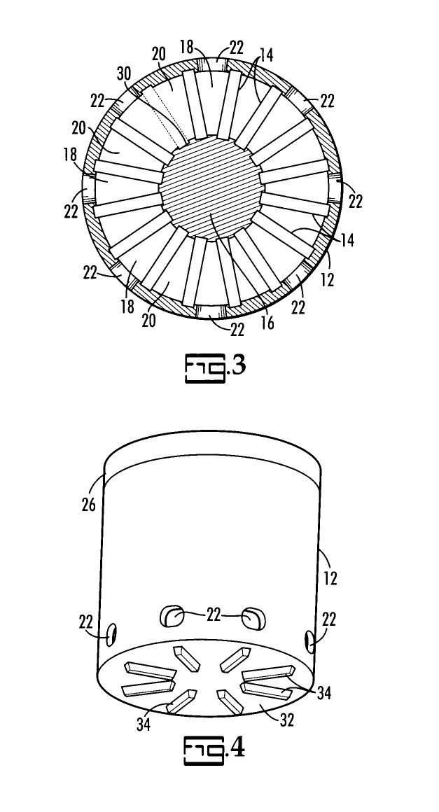

Another embodiment of the invention is illustrated in partial cut-away perspective view in FIG. 2. In FIG. 2, the canister, 12, is a cylinder with one open end and at least one port, 22, therein. For the purposes of illustration the embodiment of FIG. 2 comprises four filters, 14, around a central core, 16, defining two primary chambers, 20, and two secondary chambers, 18. A ported cover, 24, and primary cover, 26, are illustrated in exploded view for convenience of discussion. Molten metal enters the assembly through a primary cover void, 27. When the molten metal comes into contact with the ported cover the initial flow direction is through the cover ports, 25, into a primary chamber, 20. Unfiltered flow into, or out of, a chamber is referred to as direct flow whereas flow into or out of a chamber through a filter is referred to as indirect flow. Molten metal must pass through a filter, 14, to reach the secondary chamber from a primary chamber wherein it can pass out the port, 22. The primary flow path through a primary chamber is indicated by arrows 28. As the flow increases molten metal begins to flow through the ported cover at a filtering passage, 29, wherein it is filtered as represented by a flow path indicated by arrows, 30. Molten metal that flows through the ported filter at a filter passage enters a secondary chamber without passing through a primary chamber.

An advantage of the present invention is that the porous ported cover can provide additional filtering capacity. Due to the presence of the filters and core and the diffusion of the flow the porous ported cover is supported sufficiently to avoid breakage as normally occurs when a filter is subjected to perpendicular flow of high volumes of molten iron. If a solid ported cover is utilized the path through the ported cover to the secondary chamber is eliminated and all molten metal passes directly into a primary chamber.

A cross-sectional view taken along line 3-3 of FIG. 1 is provided in FIG. 3. In FIG. 3, the shell, 12; filters, 14; core, 16; primary chambers, 20; secondary chambers, 18; and ports, 22 are as described previously. The core, 16, comprises optional but preferred recessed slots, 30, for receiving the filters therein. The shell may comprise recessed slots in at least one of the bottom or side walls. Channels secure the filters in position and prohibit them from moving when the canister is moved or during use. In one embodiment the canister can be assembled in place by placing a shell in the proper orientation, inserting a core and then sliding the filters into the recessed slots of the core and/or shell. The ported cover, optionally porous, can then be placed in position followed by the primary cover or an equivalent thereto. It would be apparent that the ports of the ported cover are aligned with the primary chambers.

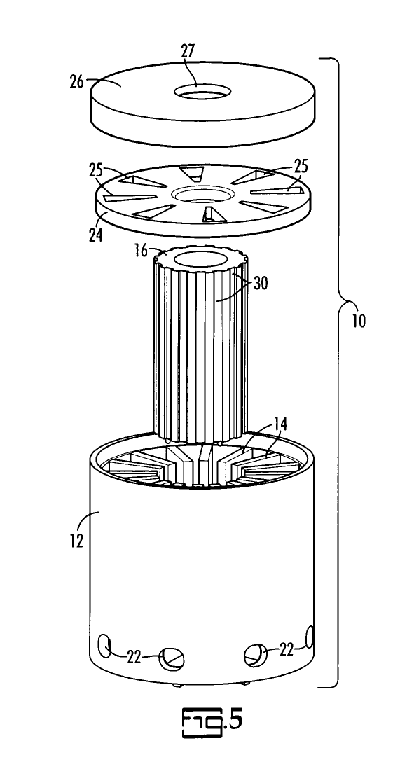

A bottom perspective view of a canister is illustrated in FIG. 4. In FIG. 4, the bottom, 32, of the shell, 12, comprises optional, but preferred, alignment projections, 34. The alignment projections assist in placement of the canister to insure the ports are properly aligned. The alignment projections preferably mate with an alignment recess which receive the alignment projections.

It would be apparent that the canister is arranged in such a way that molten iron can not flow around the canister but most flow through at least one filter of the canister.

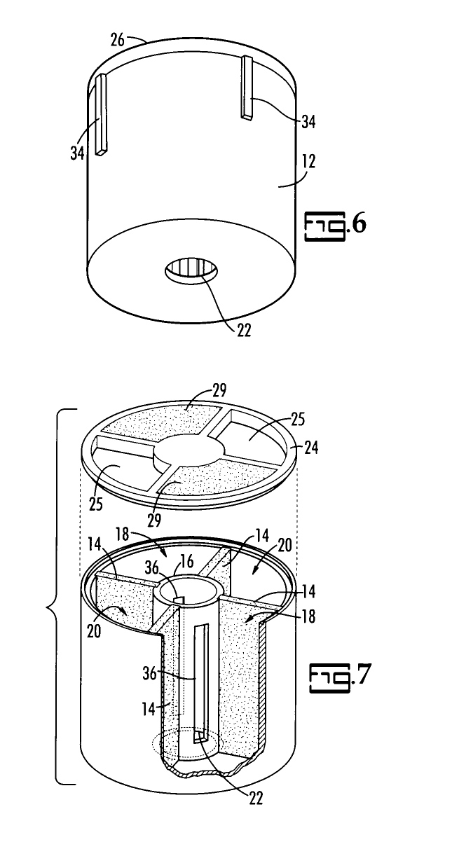

An embodiment of the invention is illustrated in exploded view in FIG. 5. The embodiment of FIG. 5 comprises ceramic components which, taken together, form a canister housing for the ceramic foam filters. As illustrated, the canister, 10, comprises a shell, 12; a core, 16; a ported cover; 24 and a primary cover, 26, as described elsewhere herein. The canister is preferable of unitary construction, however, a canister comprising a separate bottom and side walls is suitable. Likewise, the core, ported cover and primary cover are preferably each of unitary construction for manufacturing convenience with the understanding that each may be provided in multiple parts which are combined for use.

Another embodiment is illustrated in FIG. 6. In FIG. 6, the shell, 12, and primary cover, 26, are as described above. The shell has optional alignment projections, 34, as previously described. The port, 22, is in the bottom of the shell such that filtered molten metal passes downward.

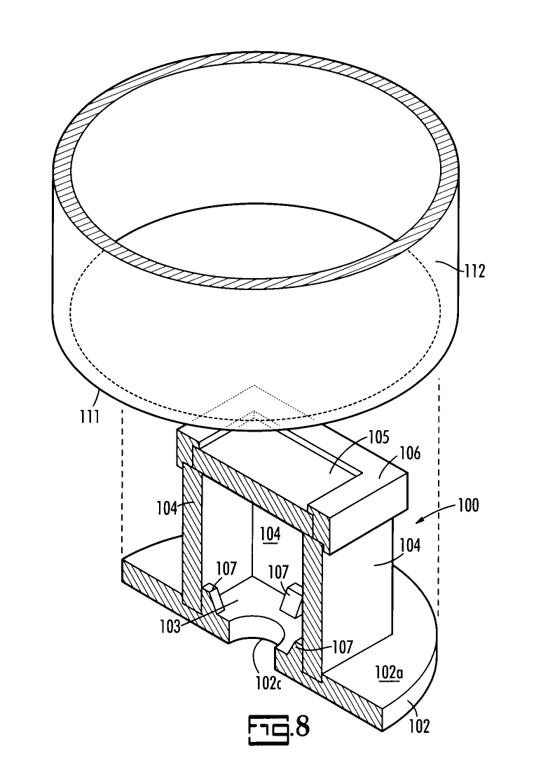

A cutaway view of an embodiment of the invention is illustrated in FIG. 7. In FIG. 7, the core, 16, is annular with a core port, 36, therein. In this embodiment the molten metal passes into the secondary chamber, 18, from the primary chamber, 20, through the filter, 14. Filtered molten metal is then discharged through the core port, 36, in the core and then through the port, 22, in the bottom of the canister, preferably in the center, as illustrated in FIG. 6.

The ported cover, 24, comprises ports, 25, which allow molten metal to flow directly into primary chamber, 20, wherein it must pass through a filter to reach a secondary chamber, 18, wherein it can exit the canisters as filtered molten metal. An optional filter passage, 29, in portal cover, 24, allows filtered molten metal to pass into a secondary chamber for discharging from the canister. In another embodiment ports may be provided in the bottom.

The number of filters is not particularly limited herein. Due to the configuration an even number of filters in a cylindrical shell is a particularly preferred embodiment. In a particularly preferred embodiment a ceramic shell with 16 individual filters in a radial pattern around a central ceramic axial core is particularly preferred. While not limited to any theory, 16 filters in a radial pattern provides a high level of surface area, owing to the large number of filters, while still allowing for port sizes of adequate size and a flow rate sufficiently large to allow an adequate amount of molten metal to pass through in a suitable amount of time. Sixteen filters provide the surface area required to effectively filter the desired quantity of molten cast iron in a large number of practical applications.

The shell can be configured to meet the specific design requirements of the individual foundry engineer's mold design. A design comprising a shell with 8 ports and 16 filters allows the molten iron to flow effectively to the runner bar of a casting's gating system. The filters are preferably placed vertically in the ceramic shell preferably in specifically designed slots recessed in both the shell and the axial core to hold the filter in place and provide the structural strength required to maintain position while the liquid iron is flowing through the casing. The invention incorporates the novel placement of vertical filters on either side of the secondary, or outlet, chamber. The molten iron then flows through the filters by the strategic positioning of the ceramic distribution wheel, or ported cover, relative to the position of the individual filters. The molten iron enters the filtration crucible through a port in the crucible cover. The walls of the primary cover, shell, distribution wheel and central axis of this system form the inlet chamber of the filtration crucible. The distribution wheel persuades the flow of molten iron from the central axis of the inlet chamber out to the periphery of the filtration crucible. The distribution wheel preferably contains 8 ports which are preferably symmetrically distributed. Each port in the distribution wheel is specifically located to dispense molten iron into a primary, or filtration, chamber formed by two vertical filters and the ceramic shell of the filtration crucible. To exit the filtration chamber, the iron must flow through the inlet edge of either filter to reach the outlet, or secondary, chamber formed by the filters and the shell of the filtration crucible. Once the iron reaches the secondary, or outlet, chamber of the crucible the metal flows to the exit ports located in the shell of the filtration crucible. The exit ports are preferably custom designed to mate perfectly with the runner bar design of the casting mold.

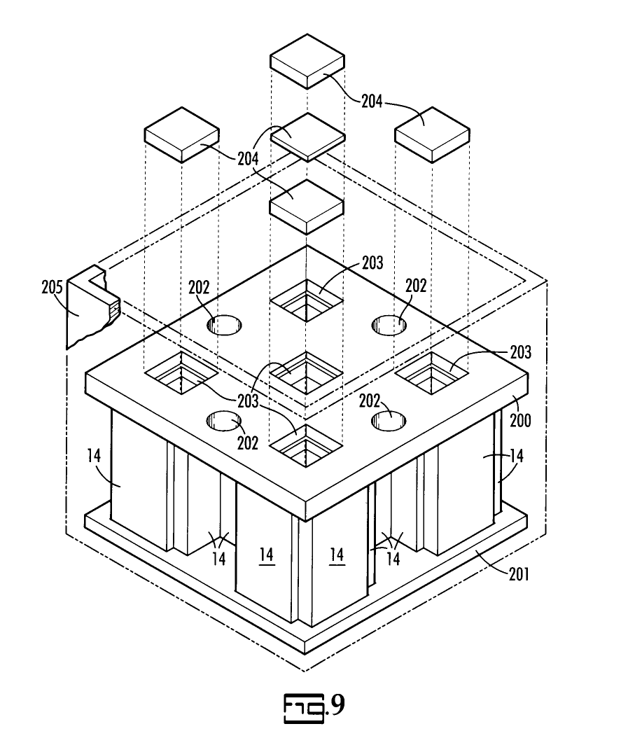

A particularly preferred filter assembly is illustrated in FIG. 8. The filter assembly, generally represented at 100, comprises a crucible base, 102, with a top surface, 102a, and a bottom surface opposite thereto. The crucible base has a port, 102c, therein. Extending from the top surface is a filter structure forming a secondary cavity, 103, with side filters, 104, and a top filter, 105 forming a cavity which is bound by the side filters, 104, top filter, 105, and crucible base, 102. A ceramic end cap, 106, secures the filter structure in place. The ceramic end cap is preferably designed to physically maintain the filters in a fixed position and/or to provide adequate surface to adhere the filter elements to the ceramic end cap thereby providing sufficient structural integrity to the filter assembly. In use, the top surface of the crucible base is sealed to the exit hole, 111, of an exit throat, 112, with the filter structure extending from the exit throat. In a particularly preferred embodiment the exit throat is the exit port of a Fischer Converter. Molten metal flows through the top and side filter elements into the secondary chamber and through the port, 102c, thereby providing filtered purified molten metal. The throat and crucible base form a canister with the primary chamber being an outer chamber and the secondary chamber being bound by filters and the base.

The side filters are preferably received by dados or recesses, 108, in the crucible base for strength. Optional lugs, 107, which are preferably integral to the crucible base provides structural integrity.

Another preferred embodiment is illustrated in FIG. 9. The filter walls are secured between a portal top plate, 200, and bottom plate, 201. The portal top plate, 200, comprises primary ports, 202, and filter ports, 203. The filter ports, 203, further comprise a port filter, 204, which is received in the filter port. The port filter, shown as a separate entity which is inserted into a port, may be integral to the portal top plate. A separate port filter is preferred for manufacturing and distribution convenience. The filters and ports are preferably similarly tapered thereby allowing the filter to rest in the filter port with little or no adhesive.

As would be realized the molten metal passes preferentially through the primary ports, 202, initially due to the flow restrictions caused by the port filters, 204, in the filter ports, 203. The entire assembly is encased in a canister, 205, thereby causing the molten metal to ultimately flow through the filters, 14, into the secondary chamber and through the outlet port. The secondary chamber and outlet port will be described below. As the pressure increases some molten metal passes through the port filters, 204, in the filter port, 203, into the secondary chamber and then through the outlet port.

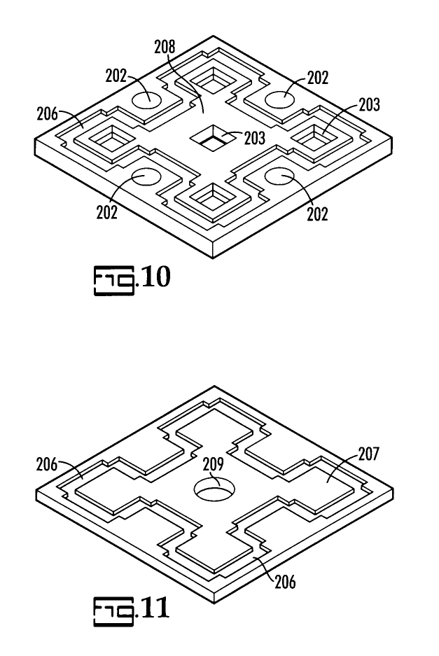

A top plate is illustrated in FIG. 10 and a bottom plate is illustrated in FIG. 11.

The top and bottom plates preferably comprise matching recessed slots, or dado's, 206, which the side filters are received in. This provides a robust assembly. The side filters may be adhered by an appropriate adhesive if desired. The secondary chamber is that interior area bound by filters, the secondary chamber floor, 207, shown in FIG. 11, and secondary chamber ceiling, 208, shown in FIG. 10. The walls of the secondary chamber would be defined by the filters which are preferably received in the matching dado's. The port, 209, allows passage of the filtered molten metal out of the secondary chamber.

Dimensions provided in the various figures are for guidance and do not limit the invention in any way. The size, and orientation of filters, will be a design choice within the scope of the invention as described herein.

The side filters may be in the form of a rectangle as illustrated and this is preferred for manufacturing convenience. In one embodiment the side filters are integral and in a preferred embodiment the side filters form a cylinder.

It is preferable that the various elements be adhered one to the other by a ceramic adhesive sufficient to withstand the temperatures of molten metal.

The invention is primarily described for use with molten iron without limit thereto. Other materials such as other metals or alloys or monomers may be filtered the present invention. In particular copper alloys, such bronze, and aluminum are mentioned.

The solid components are a material which is non-corrosive, can withstand the temperature of the material being filtered and have sufficient strength to withstand the flow for the time period of the filtering operation. The solid components may comprise ceramic refractory materials such as mullite, fused silica, silicon carbide, aluminosilicate, zirconia, silica, alumina, or blends thereof. Aluminosilicate and fused silica refractory material are most preferred. Other materials of mention include resin bonded materials, such as sand. Particularly suitable resins include acid catalyzed furan, ester cured phenolic, phenolic urethane with amine catalyst, thermal set phenolic and sodium silicate. Furan is a material containing either a furfuyral alcohol or phenol. The resin may have an additional agent which acts to cross-link or set the resin.

The filters can comprise silica-bonded silicon carbide, mullite, silica-bonded mullite or zirconia ceramic material, and more specifically silica-bonded silicon carbide ceramic material.

The pore size of the filters is selected based on the application and, particularly, the amount of material flowing through the filter and acceptable level of impurities after filtration. It is well understood in the art that, generally, larger pores allow higher throughput of molten metal with decreasing filtering capabilities. The filters can range in pore size from # 10 through # 30 which have a pore distribution from 2 to 25 ppi. In practice the pore size ranges are 2 to 4 ppi, 3 to 5 ppi, 4 to 8 ppi, 6 to 10 ppi, 13 to 18 ppi, 15 to 20 ppi and 20 to 25 ppi. The specific filter pore size selected will be determined by the application requirements.

The present invention has been demonstrated to be suitable for filtering from 100 to 65,000 kg of cast iron or 1000 to 20,000 kg of ductile iron in 2 to 160 seconds with adequate removal of impurities. This level of performance has heretofore been considered beyond the range of most filter applications.

The filters are preferably designed to filter from 0.001 to 0.10 kg/mm² of cast iron and more specifically 0.01 to 0.03 kg/mm² of ductile iron.

The crucible base, end cap and other non-filtering components are preferably ceramic material and must be a material which can withstand molten metal.

The filter material is not particularly limited except that the pore size and material of construction must be sufficient for the filtration operation of interest as known in the art.

The invention is of particular use in various foundry industry segments including; ductile iron wind energy castings, ductile iron soil pipe castings, power plant castings, oil drilling castings, paper roll castings and housing, mining industry gear castings.

Ceramic filter elements are porous members comprising continuous or semi-continuous voids or passageways through which the metal passes and in which any included particles become lodged. The porous ceramic filter elements are preferably prepared by the manner described in U.S. Pat. No. 4,056,586, which is incorporated herein by reference. Further elaboration on methods for manufacturing ceramic filter elements is provided in U.S. Pat. Nos. 5,673,902 and 5,456,833, both of which are included herein by reference. Further details of iron purification and filtration are provided in U.S. Pat. No. 6,793,707 which is incorporated herein by reference.

The present invention has been described with particular reference to the preferred embodiments without limit thereto. One of skill in the art would readily realize additional features and embodiments which are not specifically recited but which are within the scope of the claims appended hereto.

Claimed is:

1. A filter assembly for molten material comprising:
a canister comprising at least one port wherein said port allows filtered molten material to flow from said canister;
a plurality of filter elements in said canister wherein said filter elements separate a volume of said canister into a primary chamber and a secondary chamber wherein said secondary chamber is in direct flow communication with said port;
a ported cover over said canister wherein said ported cover prohibits unfiltered molten material from flowing directly into said secondary chamber; and
wherein molten material flows from said primary chamber to said secondary chamber through a filter element of said filter elements.

2. The filter assembly of claim 1 further comprising a core in said canister.

3. The filter assembly of claim 2 wherein said filter elements are radially arranged around said core and in contact with said core.

4. The filter assembly of claim 3 wherein at least one of said core and said canister comprise recessed slots for receiving said filter elements.

5. The filter assembly of claim 2 wherein said core further comprises a core port between said secondary chamber and said port.

6. The filter assembly of claim 1 wherein said ported cover further comprises at least one port filter.

7. The filter assembly of claim 6 wherein said port filter allows molten material to pass there through into said secondary chamber.

8. The filter assembly of claim 6 wherein said port filter is selected from an insertable filter and an integral filter.

9. The filter assembly of claim 1 wherein said ported cover comprises recessed slots for receiving said filter elements.

10. The filter assembly of claim 1 further comprising a bottom plate opposite to said ported cover.

11. The filter assembly of claim 10 wherein at least one of said bottom plate and said portal cover comprises grooves for receiving said filter elements.

12. The filter assembly of claim 10 wherein said bottom plate is adapted to be received by a Fischer Convertor.

13. The filter assembly of claim 10 wherein said at least one port is in said bottom plate.

14. The filter assembly of claim 1 wherein said plurality of filter elements are arranged such that said molten metal flows through said filter in a direction which is perpendicular to a primary flow.

15. The filter assembly of claim 1 further comprising a primary cover over said ported cover.

16. The filter assembly of claim 1 wherein said canister comprises a cylindrical wall with a bottom integral thereto.

17. The filter assembly of claim 16 wherein said port is in at least one location selected from said cylindrical wall and said bottom.

18. A filter assembly comprising:
a base plate comprising a face and a port;
a multiplicity of filters attached to said face forming a cavity; and
a flow of molten metal wherein said molten metal passes through said multiplicity of filters into said cavity and then through said port.

19. The filter assembly of claim 18 wherein said face is attached to a Fischer Convertor.

20. The filter assembly of claim 18 wherein said plurality of filter elements are arranged such that said molten metal flows through said filter in a direction which is perpendicular to a primary flow.

21. The filter assembly of claim 18 further comprising an end cap for securing said multiple filters in a specific orientation.

22. A filter assembly comprising:
a cover plate comprising at least one cover port;
a bottom plate opposite to said cover plate wherein said bottom plate comprises an exit port;
a multiplicity of filters between said ported cover and said bottom plate wherein said filters form a primary cavity in direct flow communication with said cover port and a secondary chamber in direct flow communication with said exit port and wherein molten metal must pass through said filter to move from said primary cavity to said secondary cavity.

23. The filter assembly of claim 22 wherein said cover plate further comprises at least one cover filter wherein molten metal can pass through said filter into said secondary cavity.

24. The filter assembly of claim 23 wherein said cover filter is received in a filter port.

25. The filter assembly of claim 22 wherein at least one of said cover plate and said bottom plate comprises a recess for receiving a filter of said filters.

26. The filter assembly of claim 22 wherein said plurality of filter elements are arranged such that said molten metal flows through said filter in a direction which is perpendicular to a primary flow.
